(19) United States
(12) Patent Application Publication
(10) Pub. No.: US 2025/0161137 A1
(43) Pub. Date: May 22, 2025

(54) WEARABLE POSTURAL AND MOBILITY ASSISTING DEVICE

(71) Applicant: REGENTS OF THE UNIVERSITY OF MICHIGAN, Ann Arbor, MI (US)

(72) Inventors: Olugbenga Peter Adeeko, JR., San Diego, CA (US); Kimberly Spranger, Trenary, MI (US); Lynette VanWelsenaers, Marquette, MI (US); Chandramouli Krishnan, Ann Arbor, MI (US); Edward Peter Washabaugh, Northville, MI (US)

(73) Assignees: REGENTS OF THE UNIVERSITY OF MICHIGAN, Ann Arbor, MI (US); WAYNE STATE UNIVERSITY, Detroit, MI (US); ELITE ATHLETE PRODUCTS CO., San Diego, CA (US)

(21) Appl. No.: 18/955,831

(22) Filed: Nov. 21, 2024

Related U.S. Application Data
(60) Provisional application No. 63/601,675, filed on Nov. 21, 2023.

(51) Int. Cl. A61H 3/00; B25J 9/00

(52) U.S. Cl. CPC A61H 3/00; B25J 9/0006; A61H 2201/1621; A61H 2201/165

(57) ABSTRACT

A mobility assisting apparatus easily arranged in configurations using elastic band assemblies to assist or resist muscles, provide feedback to the neurological systems, stabilize balance and improve movement patterns of the wearer. The apparatus consists of a chest harness, a waist belt, limb strap assemblies, varying styles of anchoring loops for elastic band attachment, elastic bands of varying difficulty or tension, and shoe attachment assemblies. The apparatus is customized for each user based on their gait or muscle asymmetries and the causes of such asymmetries. Not all components are required for each user. The elastic cord assemblies assist weak muscles, correct range of motion deficits, and/or give neuromuscular feedback during use. The chest harness counteracts the downward pull of the elastic cord assemblies on the waist belt. In addition, the chest harness/waist belt assemblies encourage upright posture and neutral spine mechanics. The anchors attached to the waist belt, chest harness and limb assemblies allow the elastic band assemblies to be attached wherever needed allowing for possibilities of correction only limited by the imagination.

### CROSS-REFERENCE TO RELATED APPLICATION

This non-provisional application claims the benefit of the filing date of U.S. Provisional Application No. 63/601,675, filed Nov. 21, 2023, the entirety of which is hereby incorporated by reference.

### GOVERNMENT SUPPORT CLAUSE

This invention was made with government support under 1R41HD111289 awarded by the National Institutes of Health. The government has certain rights in the invention.

### FIELD OF THE DISCLOSURE

The present invention relates to the field of wearable postural, mobility, and stability enhancing devices.

### BACKGROUND OF THE INVENTION

Multiple types of postural and movement pattern disabilities and asymmetries exist in the gait patterns of humans. Muscular weakness, presence of tone, range of motion deficits, neuromotor deficits, and lack of proprioceptive input all contribute to ineffective and/or painful movement patterns. Often the solution is not as simple as eliminating the underlying problem. Movement patterns become so deeply ingrained that even as the foundational problems are alleviated, the movement patterns do not change. Therapists and exercise specialists often use cuing to try to change these patterns. This cuing can be visual, verbal or manual. The manual cues are either physical touch or use of a device or tape.

The devices that are currently available on the market to address the above-listed foundational problems and/or provide cuing to improved movement patterns are either very specific for one problem, time-consuming or they are complicated to use and expensive to obtain. For example, the Modular and Minimally Constraining Lower Limb Exoskeleton for Enhanced Mobility and Balance Augmentation (U.S. Pat. No. 11,642,271 B2) and Device for Assisting Motion of a Joint (US Pub. No. 2022/0401285A1) are rigid and complicated to don. They might be effective in a research setting, but it would take half of a therapy session just to don the device. Other devices like the “foot-up” that was patented in 2002 (U.S. Pat. No. 10,980,975) can only address the foot drop issue and the “Triple Flex” that was patented in 2014 can only flex the hip, knee and ankle collectively.

Hence, many therapists, health care professionals, or exercise specialists do not use mobility cuing or assisting devices in their practices. Instead, they work on strengthening in less functional patterns and use mostly visual and verbal cueing. The manual cuing they do is limited to theraband tied on the body, hand placement or tape. These methods definitely have their place, but for bigger, grosser imbalances, they are minimally effective.

### BRIEF SUMMARY

The subject matter of the present disclosure, which is a variation of the “Speedmaker”, U.S. Pat. No. 10,166,426, addresses the underlying foundational problems and provides manual cueing for postural changes and improved movement patterns. It is an orthotic device that is easily customized by changing the placement or the durometer of the elastic band assemblies. It can be used to strengthen and correct movement and postural deviations and for proprioceptive or neuromuscular feedback. To date, it has been used successfully with foot drop, Trendelenburg gait pattern, crouched gait associated with cerebral palsy, kyphotic posture and gait asymmetries related to Parkinson's Disease, genu valgus related to weak hip external rotators, pelvic floor weakness, hemiplegia and recurvatum related to spinal cord injury, multiple sclerosis, Friedreich's ataxia, and rehabilitation for total hips and knees. However, this is just a sample of the potential uses for the device. A therapist, health professional, or exercise specialist who has access to this device is only limited by their ability to apply the principles of kinesiology.

The device is relatively inexpensive and user-friendly. It can be donned in minutes by the therapist, user, or caregiver and modified within seconds. It can be used as a training tool in a gym or clinic setting. It can also be obtained for long-term personal use.

In conclusion, the current devices available to assist or stabilize movement are hyper-specialized and complex or unaffordable and lack customizable options for those who need them. This orthotic device will fill a void in the wearable devices available to dynamically correct postural and mobility challenges in the rehabilitation of those with postural and/or movement limitations with the option for customizability in order to tailor each patient's individualized treatment plan.

The present disclosure is directed to a mobility-enhancing orthotic device that increases cueing, assists or resists muscles, and provides proprioceptive feedback through the use of elastic band assemblies that are strategically placed. For years, therapists have been using a method of tying and jerry-rigging theraband and elastic bandages to achieve a similar result that this mobility orthotic accomplishes, quickly, easily, and with better overall outcomes. It includes an exosuit formed from a kit of components including a chest harness (also referred to herein as a shoulder harness), a waist belt, limb straps, and feet attachments, some of which may be worn barefoot or in socks, and others of which may be worn over a wearer's shoes. Elastic band assemblies are attached via anchors to the limb straps, feet attachments, a chest harness, and/or a waist belt. The device thereby assists and stabilizes weak muscles, corrects range of motion deficits, improves posture, and gives proprioceptive and neuromuscular feedback. The wearable postural and mobility assisting device, or exosuit, is used as a cueing tool by physical therapists or exercise specialists. It also can be obtained by the patient for individual use as a long-term mobility aide. The exosuit is employable for corrective, rehabilitative, as well as assistive use.

### BRIEF DESCRIPTION OF THE DRAWINGS

The foregoing is a summary, and thus, necessarily limited in detail. The above-mentioned aspects, as well as other aspects, features, and advantages of the technology of the present disclosure are described below in connection with various embodiments, with reference made to the accompanying drawings.

FIG. 1 is a front view of a first configuration of the wearable postural and mobility assisting device, or apparatus, using a possible combination of styles of anchors and elastic bands;

FIG. 2 illustrates a back view of the first configuration of the apparatus using a possible combination of styles of anchors and elastic bands;

FIG. 3 is a side view of a second configuration of the apparatus, using a possible combination of styles of anchors and elastic bands;

FIG. 4 is a front view of a third configuration of the apparatus, using a possible combination of styles of anchors and elastic bands;

FIG. 5 is a rear view of the third configuration of the apparatus, using a possible combination of styles of anchors and elastic bands;

FIG. 6 is a top plan view of an anchor;

FIG. 7 is a top plan view of an adjustable anchor;

FIG. 8 is a top plan view of an adjustable combination anchor;

FIG. 9a is a top plan view of a footwear anchor;

FIG. 9b is a top perspective view of the footwear anchor of FIG. 9a;

FIG. 10 is a front view of an elastic band assembly having a removable stop at a first end thereof and a clip at a second, opposite, end thereof;

FIG. 11 is a front view of an elastic band assembly having a first clip at a first end thereof and a second clip at a second, opposite, end thereof;

FIG. 12a a is a front view of an embodiment of a shoulder harness keeper;

FIG. 12b is a front view of another embodiment of a shoulder harness keeper;

FIG. 13 is a rear view of an embodiment of a shoulder harness;

FIG. 14 is a front view of a shoulder harness extender, which may be used as a shoulder harness extender or a waist belt extender;

FIG. 15a is a side view of an embodiment of a plantar flexion anchor and assembled over an article of footwear;

FIG. 15b is a top, side, and rear perspective view of the plantar flexion anchor of FIG. 15a;

FIG. 16a is a side view of an in-shoe plantar flexion anchor;

FIG. 16b is a top perspective view of the in-shoe plantar flexion anchor of FIG. 16a, positioned within an article of footwear;

FIG. 17 is a front perspective view of a waist belt;

FIG. 18a is a view of a closure portion of the waist belt in a closed configuration;

FIG. 18b is a view of the closure portion of the waist belt in an open configuration;

FIG. 19 is a perspective view of the waist belt secured about a wearer;

FIG. 20 is a view of a reinforced waist belt, illustrating a belt;

FIG. 21 is a view of a limb strap;

FIG. 22 is a view of a limb strap secured to a leg of a wearer, with an anchor in a pocket thereof, the anchor secured to the limb strap via one or more fasteners;

FIG. 23a is a top view of a shoeless dorsiflexion anchor;

FIG. 23b is a side view of the shoeless dorsiflexion anchor of FIG. 18a;

FIG. 23c is a perspective view of the shoeless dorsiflexion anchor of FIG. 18a worn on a foot;

FIG. 24 is a view of a pair of limb straps, each provided with an adjustable anchor similar to that of FIG. 7, secured to an arm of a wearer, and a hand strap provided with an adjustable anchor, the hand strap provided with one or more rigid components;

FIG. 25 is a view of an apparatus of the present disclosure, donned by a wearer, and including a head strap with an elastic band extending between a front-facing anchor of the head strap and an anchor associated with a shoulder harness of the apparatus;

FIG. 26 is a front, top perspective view of a limb strap secured to a leg of a wearer, with an anchor, which may be a double-D anchor, secured thereto via hook-and-loop fasteners, and an elastic band extending between a lower D anchor of the double D anchor at a first end and secured to a shoelace at a second, opposite end;

FIG. 27 is a front view of a kit of the present disclosure, donned by a wearer, in a first configuration;

FIG. 28a is a front view of the kit of the present disclosure, donned by a wearer, in a second configuration;

FIG. 28b is a rear view of the kit of the present disclosure, donned by a wearer, in the second configuration;

FIG. 29 is a rear view of the kit of the present disclosure, donned by a wearer, in a third configuration;

FIG. 30a is a front view of the kit of the present disclosure, donned by a wearer, in a fourth configuration;

FIG. 30b is a rear view of the kit of the present disclosure, donned by a wearer, in the fourth configuration;

FIG. 31a is a front view of the kit of the present disclosure, donned by a wearer, in a fifth configuration;

FIG. 31b is a rear view of the kit of the present disclosure, donned by a wearer, in the fifth configuration;

FIG. 32a is a front view of the kit of the present disclosure, donned by a wearer, in a sixth configuration;

FIG. 32b is a rear view of the kit of the present disclosure, donned by a wearer, in the sixth configuration;

FIG. 33a is a front view of the kit of the present disclosure, donned by a wearer, in a seventh configuration;

FIG. 33b is a rear view of the kit of the present disclosure, donned by a wearer, in the seventh configuration;

FIG. 34a is a front view of the kit of the present disclosure, donned by a wearer, in an eighth configuration;

FIG. 34b is a rear view of the kit of the present disclosure, donned by a wearer, in the eighth configuration;

FIG. 35a is a front view of the kit of the present disclosure, donned by a wearer, in a ninth configuration;

FIG. 35b is a rear view of the kit of the present disclosure, donned by a wearer, in the ninth configuration;

FIG. 36 is a rear view of the kit of the present disclosure, donned by a wearer, in a tenth configuration;

FIG. 37a is a front view of the kit of the present disclosure, donned by a wearer, in an eleventh configuration;

FIG. 37b is a rear view of the kit of the present disclosure, donned by a wearer, in the eleventh configuration;

FIG. 38a is a front view of the kit of the present disclosure, donned by a wearer, in a twelfth configuration;

FIG. 38b is a rear view of the kit of the present disclosure, donned by a wearer, in the twelfth configuration;

FIG. 39a is a front view of the kit of the present disclosure, donned by a wearer, in a thirteenth configuration;

FIG. 39b is a rear view of the kit of the present disclosure, donned by a wearer, in the thirteenth configuration;

FIG. 40 is a perspective view of a ratchet system for providing a length-adjustable elastic band;

FIG. 41 is an elevation view of a knob-adjustable cable system for adjusting the effective length of an elastic band;

FIG. 42a is a front view of a shoulder harness and shoulder harness keeper of a kit of the present disclosure;

FIG. 42b is a front view of a limb strap assembly, having double D anchors secured thereto, of a kit of the present disclosure;

FIG. 42c is a front view of a waist belt assembly of a kit of the present disclosure with a plurality of anchors secured to the waist belt;

FIG. 42d illustrates a group of elastic cord assemblies of a kit of the present disclosure;

FIG. 42e is a perspective view of a plantar flexion anchor of a kit of the present disclosure;

FIG. 42f illustrates a dorsiflexion anchor of a kit of the present disclosure;

FIG. 42g illustrates a dorsiflexion anchor of a kit of the present disclosure;

FIG. 42h is a rear view of a plantar flexion anchor of a kit of the present disclosure;

FIG. 42i is a front view of a limb strap assembly, having double D anchors secured thereto, of a kit of the present disclosure;

FIG. 42j is another view of a limb strap assembly, having double D anchors secured thereto, of a kit of the present disclosure

FIG. 42k illustrates a group of elastic cord assemblies of a kit of the present disclosure;

FIG. 42l illustrates a limb strap assembly, having a double D anchor secured thereto, of a kit of the present disclosure; and

FIG. 43 illustrates a shoulder harness and shoulder harness keeper of a kit of an embodiment of the present disclosure.

The illustrated embodiments are merely examples and are not intended to limit the disclosure. The schematics are provided to illustrate features and concepts and are not necessarily drawn to scale.

### DETAILED DESCRIPTION OF THE PREFERRED EMBODIMENTS

The foregoing is a summary, and thus, necessarily limited in detail. The above-mentioned aspects, as well as other aspects, features, and advantages of the present technology will now be described in connection with various embodiments. The inclusion of the following embodiments is not intended to limit the disclosure to these embodiments, but rather to enable any person skilled in the art to make and use the claimed subject matter. Other embodiments may be utilized, and modifications may be made without departing from the spirit or scope of the subject matter presented herein. Aspects of the disclosure, as described and illustrated herein, can be arranged, combined, modified, and designed in a variety of different formulations, all of which are explicitly contemplated and form part of this disclosure.

Despite therapists and exercise specialists using cuing to try to change movement and/or postural patterns, the solution is not as simple as eliminating the underlying problem. Movement patterns become so deeply ingrained that even as the foundational problems are alleviated, the movement patterns do not change.

Conventionally available devices to address the above-listed foundational problems and/or provide cuing to improved movement patterns are either very specific for one problem, time-consuming, or they are complicated to use and expensive to obtain. For example, some conventional devices are rigid and complicated to don. They might be effective in a research setting, but it would take half of a therapy session just to don the device. Other devices can only address the foot drop issue or can only flex the hip, knee, and ankle collectively.

Hence, many therapists, health care professionals, or exercise specialists do not use mobility cuing or assisting devices in their practices. Instead, they work on strengthening in less functional patterns and use mostly visual and verbal cuing. The manual cuing they do is limited to a theraband tied on the body, hand placement, or tape. These methods have their place, but for bigger, grosser imbalances, they are minimally effective.

The present disclosure addresses the underlying foundational problems identified above and provides manual cuing for postural changes and improved movement patterns. Described herein are orthotic devices that are easily customized by changing the placement or the durometer of one or more elastic band assemblies. The devices described herein can be used to strengthen and/or correct movement and postural deviations and improve proprioceptive or neuromuscular feedback. The devices described herein have been used successfully to treat foot drop, Trendelenburg gait pattern, crouched gait associated with cerebral palsy, kyphotic posture and gait asymmetries related to Parkinson's Disease, genu valgus related to weak hip external rotators, pelvic floor weakness, hemiplegia and recurvatum related to spinal cord injury, multiple sclerosis, Friedreich's ataxia, and rehabilitation for total hips and knees. However, this is just a sample of the potential uses for the devices described herein. The devices described herein may have substantially unlimited use cases by applying the principles of kinesiology.

The devices described herein can be donned in minutes by the therapist, user, or caregiver and modified within seconds. The devices described herein can be used as a training tool in a gym or clinic setting and/or used for long-term personal use.

Taken together, the current devices available to assist or stabilize movement are hyper-specialized and complex or unaffordable and lack customizable options for those who need them. The orthotic devices described herein address the voids in the wearable devices available to dynamically correct postural and mobility challenges in the rehabilitation of those with postural and/or movement limitations with the option for customizability in order to tailor each patient's individualized treatment plan.

With reference to the drawing figures, a wearable postural and mobility assisting device of some embodiments is provided in the form of a kit of components. The kit of components may be used to form an exosuit, which can be donned by a wearer in a vast variety of configurations, to address rehabilitative, corrective, assistive mobility, and/or stability needs of the wearer.

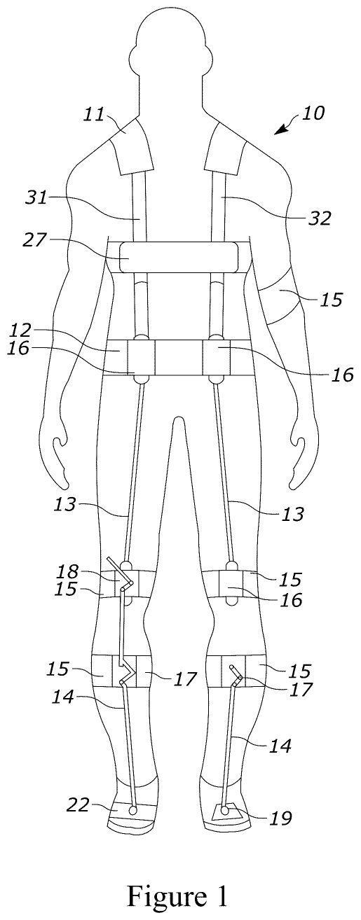

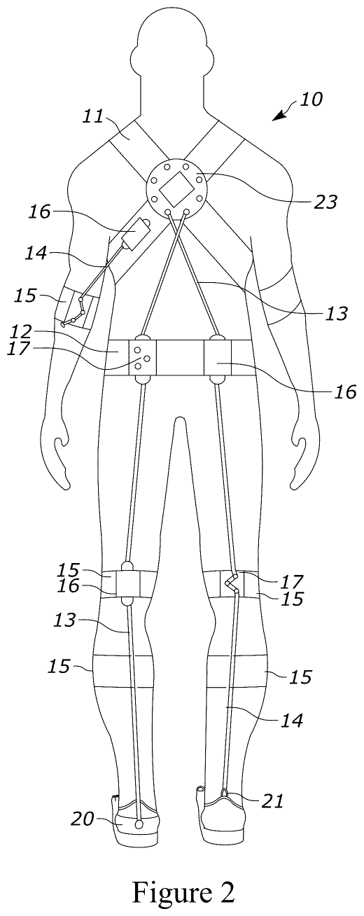

FIGS. 1 and 2 illustrate a configuration of an embodiment of the wearable mobility assisting device 10. The wearable mobility assisting device 10 may include a chest and shoulder harness assembly 11 (also referred to herein as a shoulder harness assembly), a waist belt assembly 12, elastic band or cord assembly 13, adjustable elastic band or cord assembly 14, one or more limb strap assemblies 15, one or more anchors 16, which may, by way of example only, be a double-D anchor, one or more adjustable anchors 17, an adjustable anchor combination 18 (or combo, for example a double D anchor coupled with an adjustable anchor), a shoe insert assembly 19, a plantar flexion anchor 20, a plantar flexion anchor 21, a dorsiflexion anchor 22, a shoulder harness keeper 23, and a chest and shoulder harness extender 27. The elastic bands 13 and adjustable elastic bands 14 may be latex, but it is found that non-latex silicone-based elastic bands can withstand greater cycles than latex-based elastic bands without breaking, and some patients and clinicians may have latex allergies.

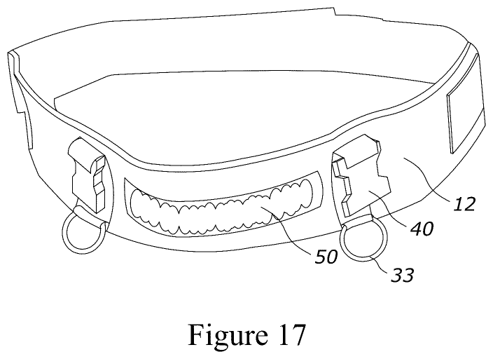

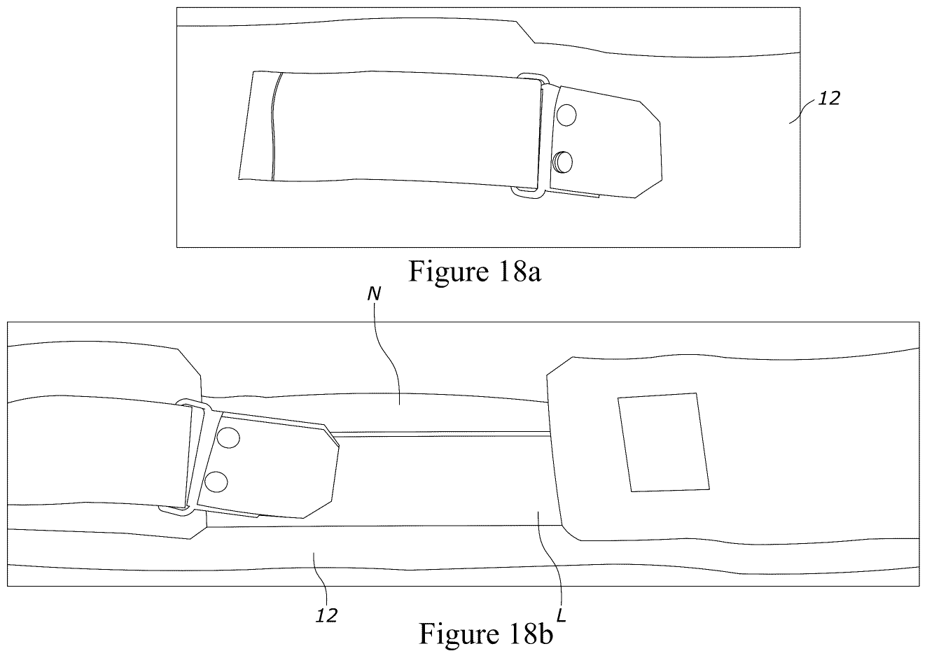

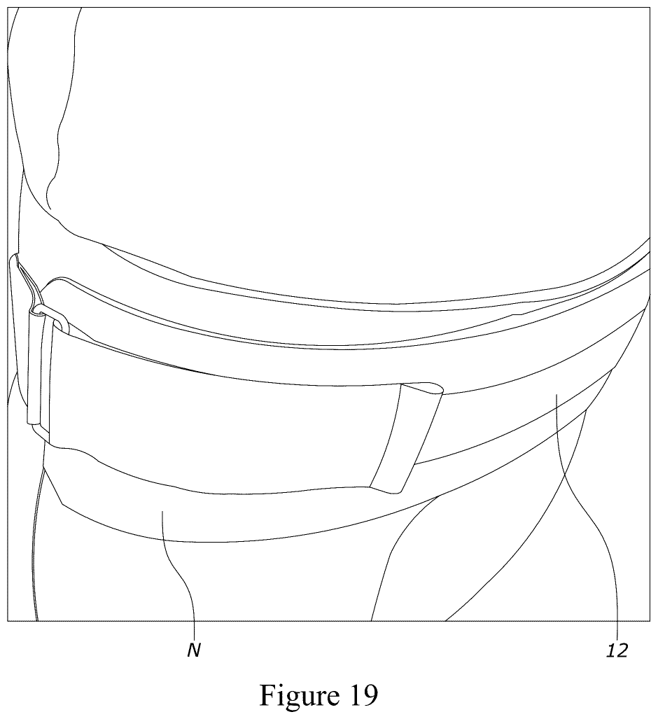

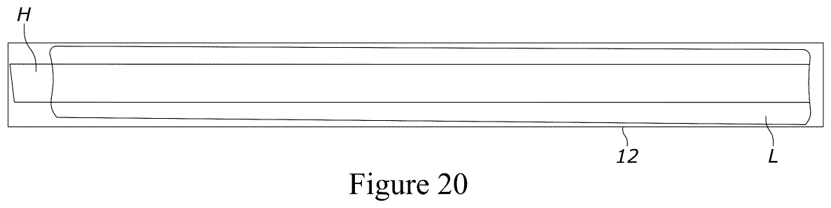

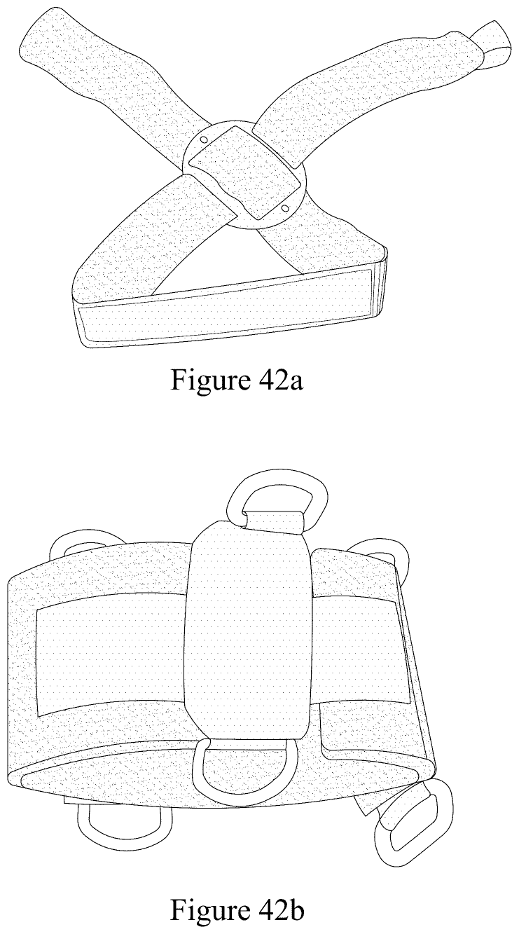

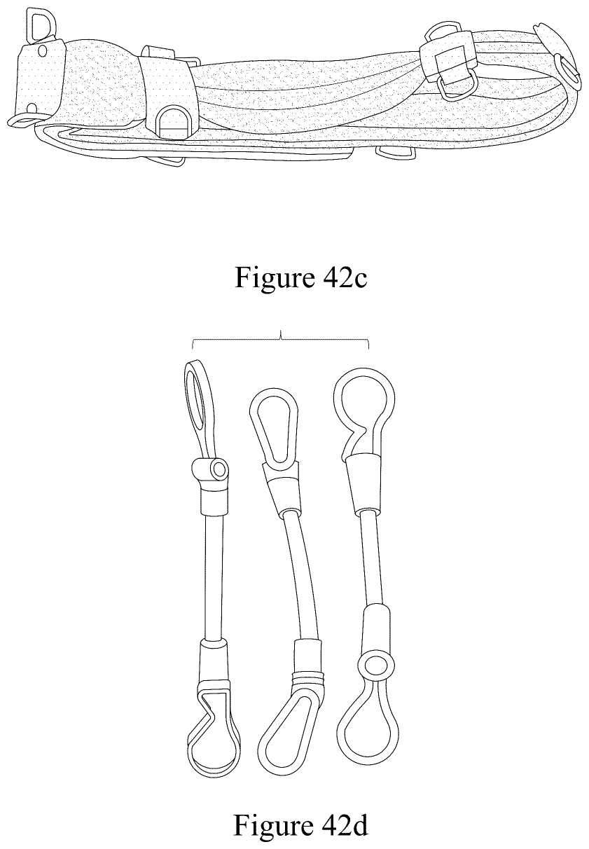

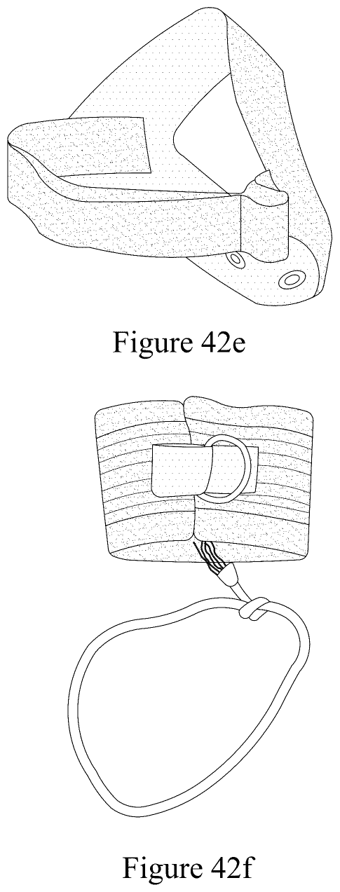

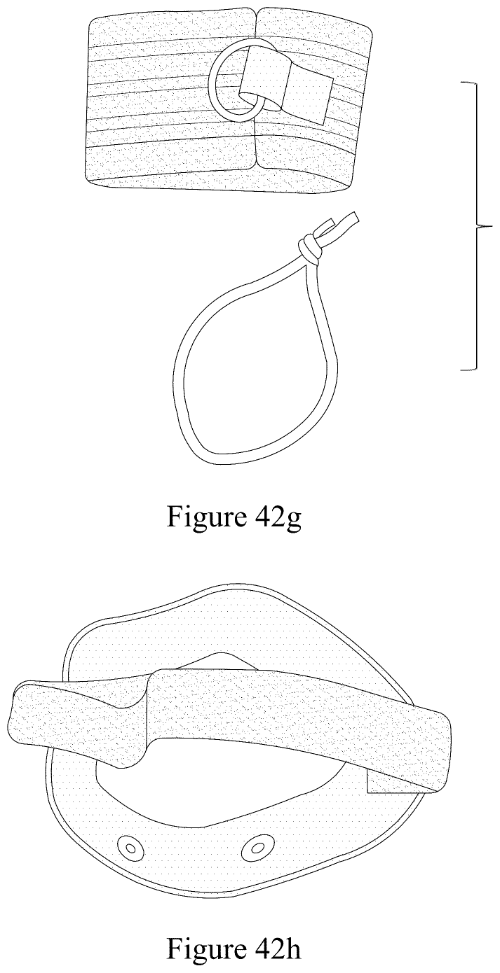

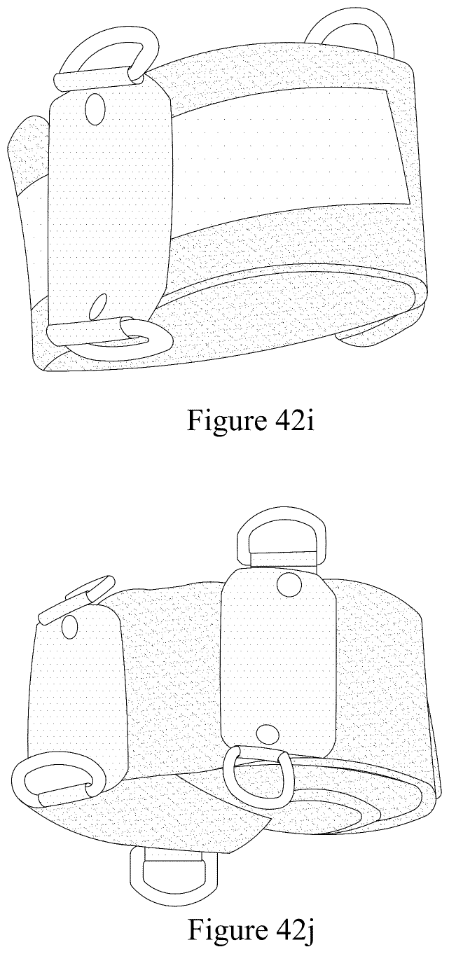

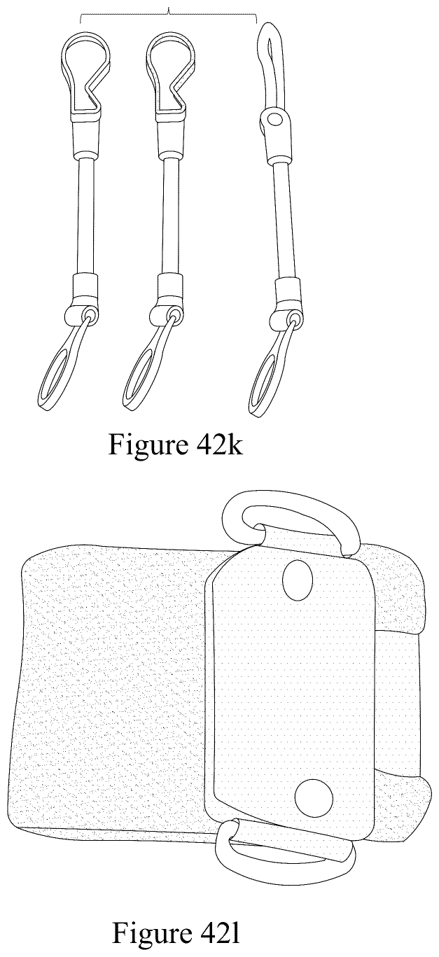

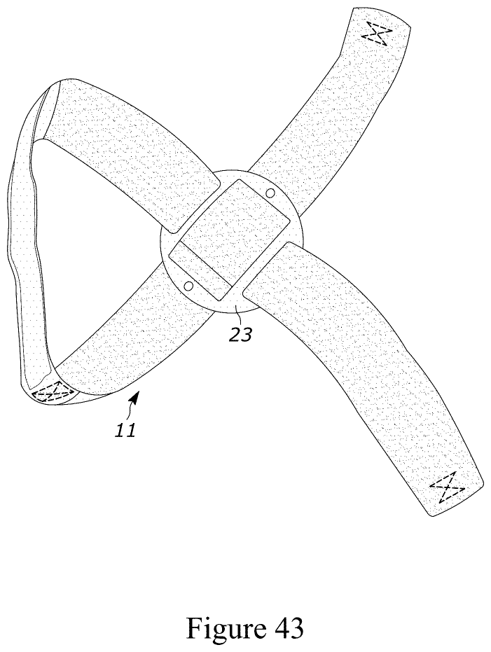

In some embodiments, the waist belt assembly 12 may include, be formed by, or be made substantially of, for example, a polychloroprene Neoprene material base N that has a multiplicity of loops on an outside surface (facing away from the body of a wearer) with a strip of hook connection material. A strip of loop material L having a width of approximately 2″, sewn or otherwise affixed along a substantial portion of the length of the Neoprene material base N of the waste belt assembly 12. The hook connection material may be coupled or affixed along a substantial portion of a length of the waist belt assembly 12. As illustrated in FIGS. 18a, 18b, 19, 20, and 42c the hook material H and loop material L provided on the waste belt assembly 12 may allow a user to easily secure the waist belt assembly 12 about their mid-section and adjust to the appropriate size. In some embodiments, the waist belt assembly 12 may preferably be produced in a single size and can be trimmed to a customized, yet still adjustable, size for a particular wearer or group of wearers. Alternatively, the waist belt assembly 12 may be produced in a plurality of sizes based on conventional or known sizes of a particular wearer or group of wearers. The waist belt assembly 12 may include or be formed of a reinforcing material made of 2″ loop material L sewn the length of the belt on an internal surface (facing a body of a wearer). Anchors 16, 17, 18 may be made with a hook material on a first side and a loop material on a second side. The double D rings may be reinforced with webbing in between the one or more layers of the hook and loop material. The anchors 16, 17, 18 can be attached anywhere on the waist belt assembly 12 (as illustrated in FIG. 42c), limb strap assemblies 15 or shoulder harness assemblies 11. One or more of the shoulder harness assembly 11, the waist belt assembly 12, or the limb strap assemblies 15 may be made with loop attachment surface on an outside thereof, allowing for infinitely-variable placement of the anchors 16,17,18 on the respective assemblies 11, 12, 15.

In some embodiments, the waist belt assembly 12 is made of a Neoprene with a loop outer surface and webbing material with a square loop attached to one end and fastened in the front with a removable coupling element (e.g., an alligator hook closure or other suitable closure device). Accordingly, the waist belt assembly 12 may be length adjustable. One or more loop anchors suitable for use with this waist belt assembly 12 may include or be formed of a webbing with plastic reinforcement. In an embodiment, as illustrated in FIG. 17, the waist belt assembly 12 may be provided with one or more clips 40 (such as plastic buckle clips) to facilitate clipping the waist belt assembly 12 to complementary buckles at a lower end portion of one or more front straps (e.g., suspender-type straps) extending downward from the chest and shoulder harness assembly 11, as well as rings 33 (which may, for example, be D-shaped or other have some other suitable shape). A front of the waist belt assembly 12 may further be provided with a panel 50 which may be provided with indicia thereon, such as branding. The panel 50, and/or indicia thereon, could be used to help align and center the waist belt assembly 12 about the wearer when donning the kit 10.

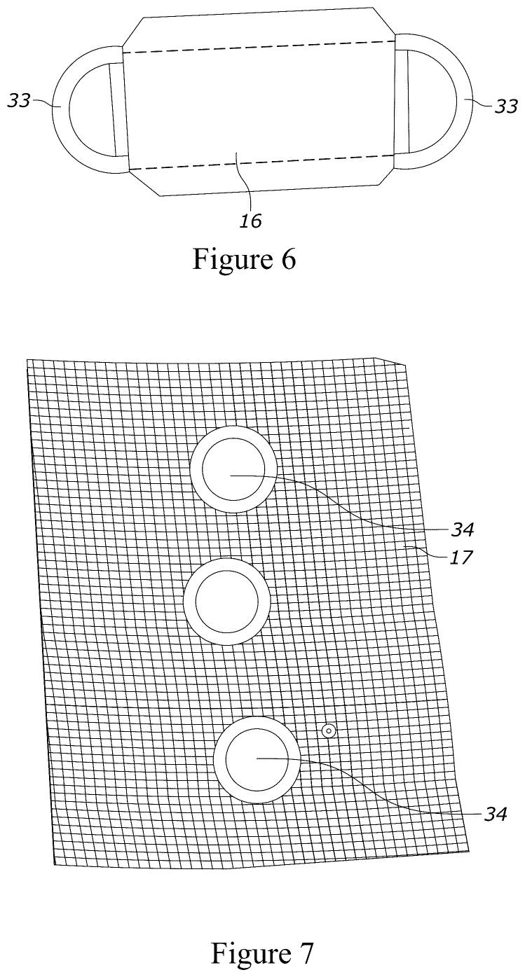

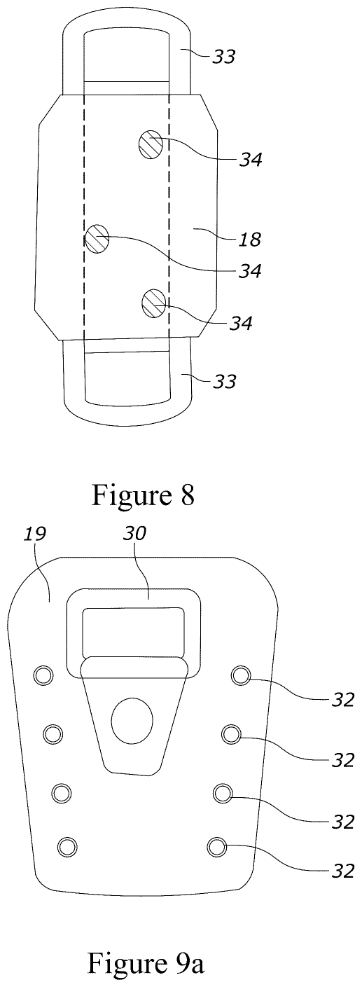

The waist belt assembly 12 may be used to attach the chest and shoulder harness assembly 11 and multiple anchor points for the elastic band or cord assemblies 13, 14. The anchors may be embodied by any of several configurations, including a double D anchor 16 (FIG. 6), an adjustable anchor 17 (FIG. 7), a double D anchor/adjustable anchor combo 18 (FIG. 8), a plantar flexion anchor 20 (including a loop 33a, which may be made of a durable fabric material, plastic, rubber, metal, or other suitable material), a plantar flexion anchor 21, or a dorsiflexion anchor 22. Flexible anchors 17 may be in the form of a sheet including a plurality of apertures 34, which may be offset from one another. The flexible anchors 17 may cooperate with elastic band assemblies, such as an elastic band assembly 14, having an elastic band 25 provided with a clip 24 (e.g., a carabiner clip or the like) at a first end and a removable stop 28 at a second, opposite end. In use, the elastic band 25 can be woven through the apertures 34 of the flexible anchor 17 so as to provide tension to a desired side of the flexible anchor 17. These anchors can also be configured by other means for the purpose of attaching elastic cord assemblies 13, 14 to the limb. The waist belt 12 functions to stabilize much of the wearable mobility-assisting apparatus.

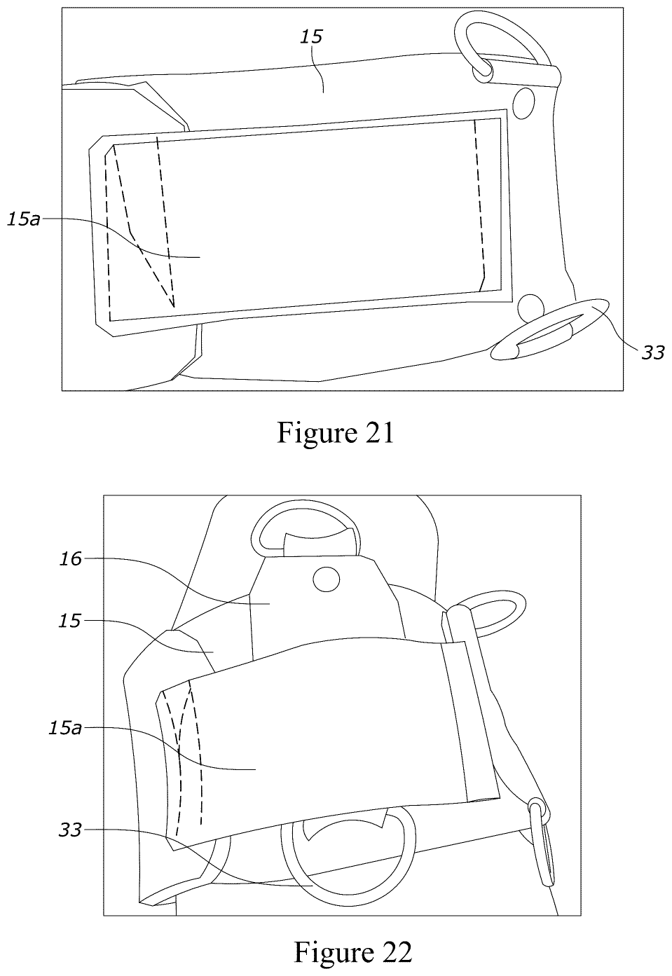

In some embodiments, wrapped around a user's legs or arms are the limb strap assemblies 15. These limb strap assemblies 15 may be used to provide an anchor point for the elastic band assemblies 13, 14. The limb strap assemblies 15 may be formed or made of Neoprene with outside loop fabric on to which the hook anchors 16, 17, 18 may be attached. The closure of the limb strap assembly 15, which, by way of example only, may be sewn on, is preferably a 2″ strip of hook material (though other widths are possible, ranging, for example, from 1.5″ to 3″, and the width need not be uniform along the length). This allows adjustment for comfort and tightness. Each limb strap assembly 15 can be trimmed for length, and may optionally be provided with a pocket 15a (as illustrated in FIGS. 21, 22) that is open on both top and bottom. The various styles of anchors 16, 17, 18 may be positioned onto the wrap (e.g., Neoprene or similar material) allowing the elastic band assemblies 13, 14 to attach and provide, or support, external cuing, muscle assistance or resistance and proprioceptive feedback.

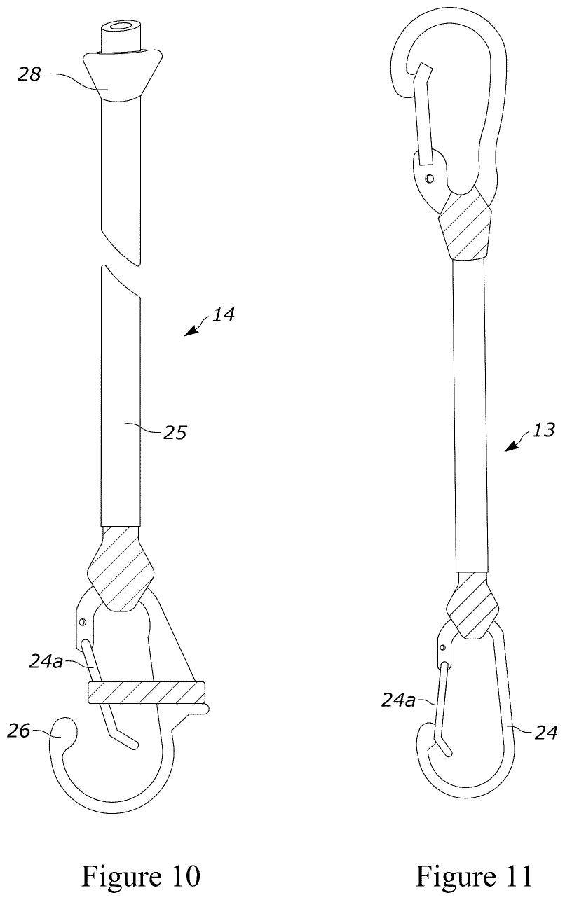

One or more elastic cord assemblies 13, 14 may couple the waist belt assembly 12 and leg strap assembly 15 to one another. In some embodiments, the cord assemblies 13, 14, shown in FIGS. 10 and 11, may be made of an elastic cord and one or two means of connections at either end. In some configurations, the elastic cord assembly 13 may include a connector 24 (e.g., a carabiner or similar connector) made of metal with a clasp 24a (which clasp 24a may, by way of example, be spring-loaded, tensioned, or pressure activated) on each end. The cord assembly 13 may be made of a variable durometer hollow rubber tube 25. In order to make the elastic band assembly of variable length when used in conjunction with the adjustable anchor 17, a removable stop 28 may be used.

Other embodiments may have an elastic cord instead of the elastic band or other elastic materials as well as a means of adjusting the length of the elastic cord assembly. Other embodiments may have a different type of connecting means at the ends of the elastic material 28.

Another variation of the carabiner 26 is one in which the spring-loaded closure can be locked open for ease of donning or doffing the device.

In some embodiments, the chest and shoulder harness assembly 11 may be worn on the torso of a user. The chest and shoulder harness assembly 11 may connect the waist belt assembly 12 using one or more straps 31, 32. The one or more straps 31, 32 may run vertically down the front of the torso over the shoulder and crisscross the wearer's back going through the shoulder harness keeper 23 and wrap around to the front where they are placed just below the breasts. The straps of the chest harness assembly 11 that crisscross on the user's back may be made of Neoprene and nylon webbing with hook and loop sewn on the nylon webbing. The straps of the chest harness assembly 11 are connected to the belt 12 using anchors 16. The vertical webbing with hook and loop goes through the anchor 16 and may be adjustable for the torso length with hook and loop on straps 31, 32.

In another embodiment, the chest harness is made of an elastic material or some other material. The straps 31, 32 may also have an adjustable feature that allows the harness to fit a range of wearers. In other embodiments, the strapping may include quick-release buckles or another arrangement of adjustment systems.

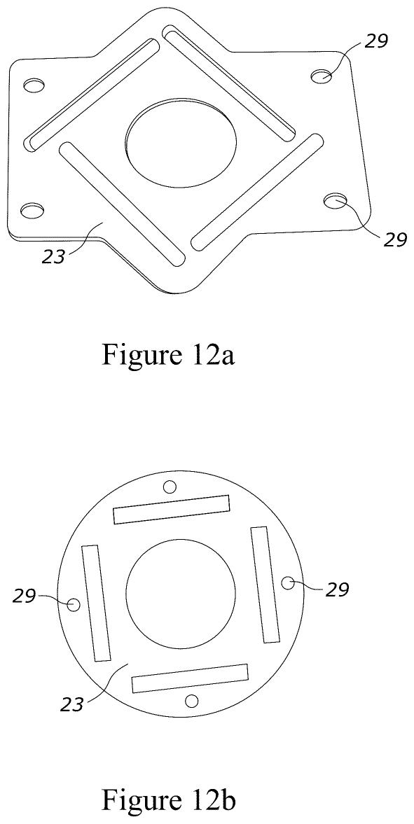

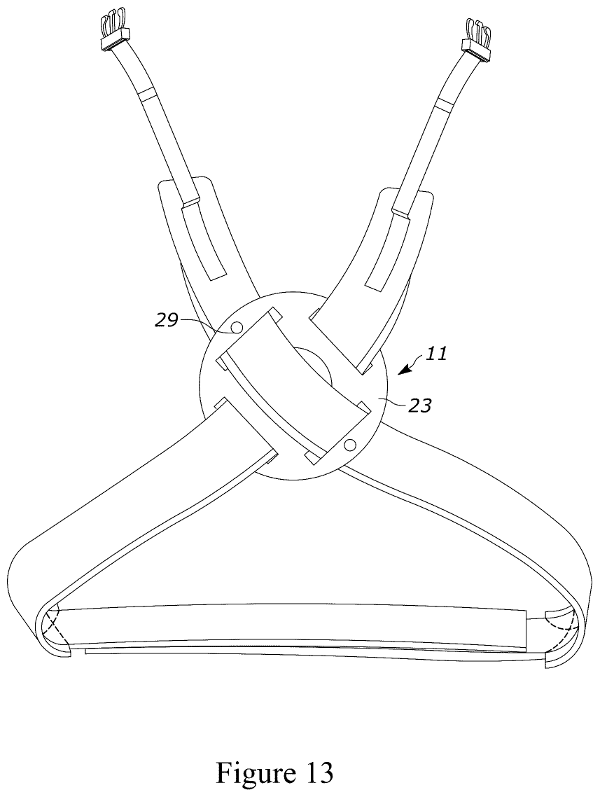

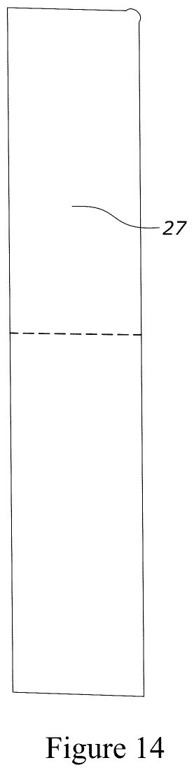

As illustrated in FIGS. 12a, 12b, and 13, the shoulder and chest harness 11 may have a harness keeper 23. The harness keeper 23 may be provided in various shapes, and may be made of a plastic, such as a low density polyethylene (LDPE), or fabric webbing that allows a flow-through interchange of the Neoprene straps 31, 32 crossing on a user's back. This harness keeper 23 maintains the orientation and placement of the straps on the user's torso. The harness keeper 23 defines elastic band attachment holes 29 to allow for attachment of one or more elastic band assemblies 13, 14 to enable trunk extension or trunk movement. In another embodiment, the harness keeper 23 may have a variation for connections of one or more elastic band assemblies 13, 14 to allow different configurations to promote functional movement of the trunk and pelvis and upper extremities. The harness keeper 23 may also define two pairs of parallel rectangular elongate apertures inboard of the elastic band attachment holes 29. The elongate apertures may have a rectangular shape, but other polygonal or ovoid shapes are also envisioned, such as an elongate oval. The elongate apertures serve as chest harness inserts. The shoulder harness 11 includes a first strap and a second strap. The first strap and second strap are arranged such that the second strap crosses over the first strap. Each of the first strap and the second strap passes through the harness keeper 23 and through the elongate apertures. At the intersection where the second strap crosses over the first strap, the first strap passes through the harness keeper 23 in a first direction and the second strap passes through the harness keeper in a second direction perpendicular to the first direction.

Anchors shown in FIGS. 6, 7, 8, 9a, and 9b are the attachment points between the waist belt assembly 12, the limb strap assemblies 15, the shoulder harness assembly 11, and the feet-engaging portions of the wearable postural and mobility assisting device 10. In some embodiments, the anchors 16, 17, 18 are made of hook material on one side and loop material on the other, with the rings 33 reinforced and secured inside the hook material, and loop material supporting securement of the anchor with webbing, and/or a sewn-in and/or riveted closure. The rings 33 allow easy attachment to any of the elastic cord assemblies 13,14 while permitting freedom of movement relative to the body part(s) to which the anchor 16, 17, or 18 is secured. The adjustable anchor 17 is made in a similar way and defines one or more holes 34 to facilitate coupling of the variable length elastic tubing. The anchor combo 18 may be constructed in a similar manner as the anchor 16, defining one or more holes 34, at least one of which may be offset from the others, to accommodate the adjustable length elastic tubing.

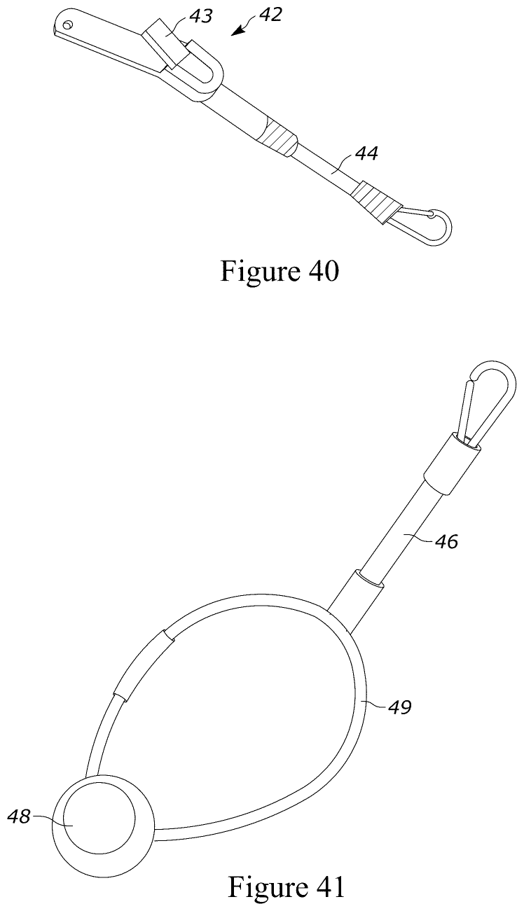

Various alternative anchor configurations are contemplated for use with the kit of the present disclosure. For instance, as illustrated in FIG. 40, one or more of the elastic bands may be secured to a ratchet system including a button-activated rachet mechanism 42, including a button 43 that can be selected (e.g., pushed), for instance by a thumb, by which a length of that length-adjustable elastic band 44 and ratchet system is adjustable. Alternatively, as illustrated in FIG. 41, one or more of the elastic bands 46 may be secured to an adjustable cable system, which may include a cable 49 and an input element 48, such as a rotatable knob like the dial-based tensioning mechanism available from Boa Technology, Inc., Denver, Colorado, which may enable dial-based tensioning to adjust an effective length of each elastic band secured to the knob-adjustable cable system, thereby adjusting the tension of one or more elastic bands secured to the adjustable anchor due to a change in nominal stretch of the one or more elastic bands.

Another version of the anchor has two rings 33, one on either end, each of which may be D-shaped, with a plastic stiffener incorporated into the webbing. This is slid on the limb strap assembly 15 or waist belt assembly 12. Another option would be an attachment anchor made of webbing of various widths and having a plastic stiffener to work with the limb strap assemblies; one end may be provided with a ring 33, which may be D-shaped, to attach the elastic band assembly 13. Anchor 16 may slide onto the limb strap assemblies 15 for elastic cord assembly 13 attachment. Quick-release anchors may be used to connect the chest harness 11 to the waist belt 12. The quick-release anchor may include various widths of webbing 26 with a plastic stiffener, a quick-release buckle on one end and a ring 33 on the other.

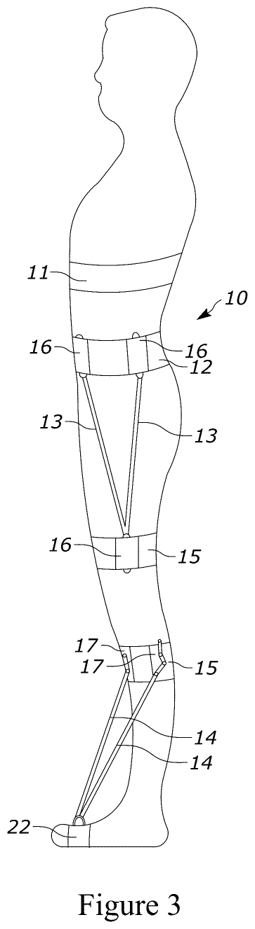

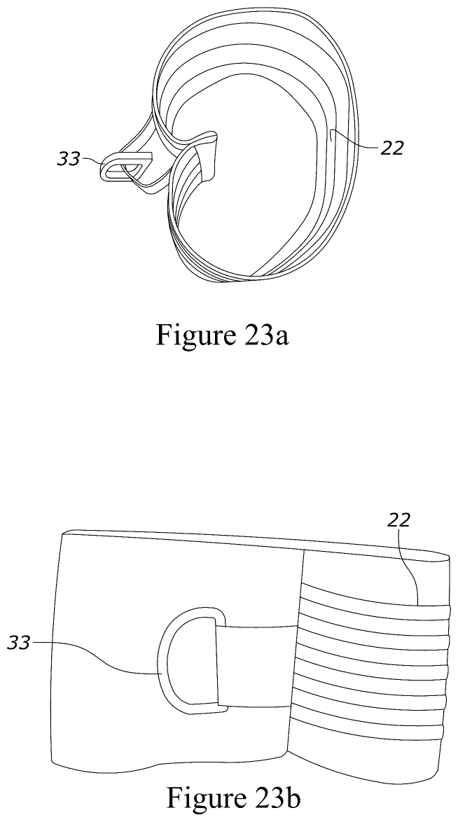

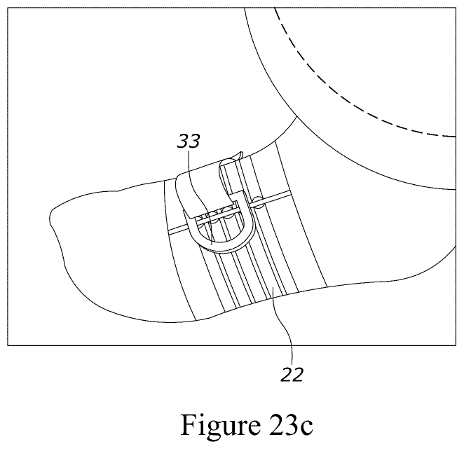

The footwear insert assembly 19 is used to easily attach the elastic band assembly 13 to a footwear article of the wearer, encouraging dorsiflexion to occur. In some embodiments, it is made with leather or thin flexible plastic with a ring 30, which may be D-shaped, attached. The thin flexible plastic or leather may have shoelace-receiving holes 32 to allow the user to lace their shoe laces through the holes 30 and affix the insert in a stable configuration in their shoe for elastic cord assembly connection. In FIG. 1, the shoe insert assembly 19 is used in conjunction with the limb strap assembly 15 and the adjustable anchor 17 to provide a dorsiflexion assist for the user. In FIG. 3, two adjustable anchors 17 are used with the limb strap assembly 15 to cause dorsiflexion and in-toeing optimally aligning the joints and allowing neuromuscular reeducation with each step or exercise. The dorsiflexion anchor 22 may be used over the shoe, but it can also be used with bare feet or over a socked foot (as illustrated in FIGS. 23a, 23b, 23c).

FIGS. 1 and 2 show a configuration of the wearable postural and mobility assisting device 10. In this setup, the user may be standing and sitting up taller through the utilization of the chest harness assembly 11 by assisting the core for stability. The user also has bilateral hip flexors and hip extensors along with plantar, dorsiflexion and trunk extension. This would allow improved utilization of the joints for proper muscle training and placement and ambulation.

FIG. 3 is a side view of a variation of the wearable postural and mobility assisting device 10. This configuration includes the waist belt assembly 12, with two elastic band assemblies 13, connected to the limb assembly 15 at the lower thigh on the lateral side. This set up provides the following cuing during functional movement: It assists the hip flexors in flexion and causes the hamstring to work harder. It also assists the abductors, causing the adductors to become stronger and stabilize the medial to lateral limb movement. This configuration could be used with a total hip replacement for cueing and strengthening. The lower limb is being assisted in dorsiflexion, out toeing and eversion by the limb strap assembly 15, adjustable anchors 17, elastic band assemblies 14 and dorsiflexion anchor 22. This provides the user feedback for optimal foot placement and reduces tripping, especially for those with foot drop or neuromuscular deficits in the lower limbs.

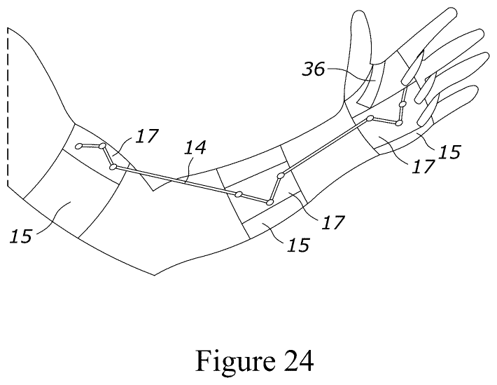

Utilizing the limb strap assemblies 15 along with the elastic band assemblies 13 allows the same neuromuscular reeducation to occur in the upper extremities. In some embodiments, as illustrated in FIG. 24, the bicep, forearm, wrist and hand are connected with elastic cord assemblies 13 to retrain the users muscles as to what it feels like to rest in a neutral position and move their hand into a functional position. By assisting the weak muscles and resisting the strong muscles a neutral, functional position is maintained retraining the user's neuromuscular pathways.

As illustrated in FIG. 24, elastic cord assemblies may be secured to the hands of a wearer by, for example, adjustable anchors 17 worn on the palm and/or the back side of the hand. One or more hard interfaces 36 may be provided on the palm side and/or the back side of the hand, as it is beneficial to provide some rigidity, while maintaining flexibility, such as at a joint. Many of the anatomic connection points of the assemblies or components of the kit 10 may benefit from being made rigid, at least in part. For instance, components secured to a shin, a calf, a thigh, an abdomen, a chest, a forearm, an upper arm, a shoulder, a neck, an ankle, a knee, or a foot would benefit from having rigid or non-soft portions.

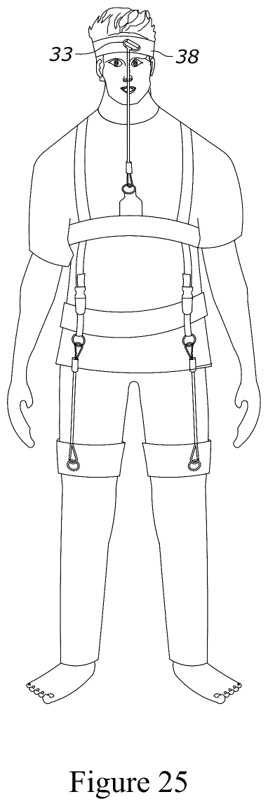

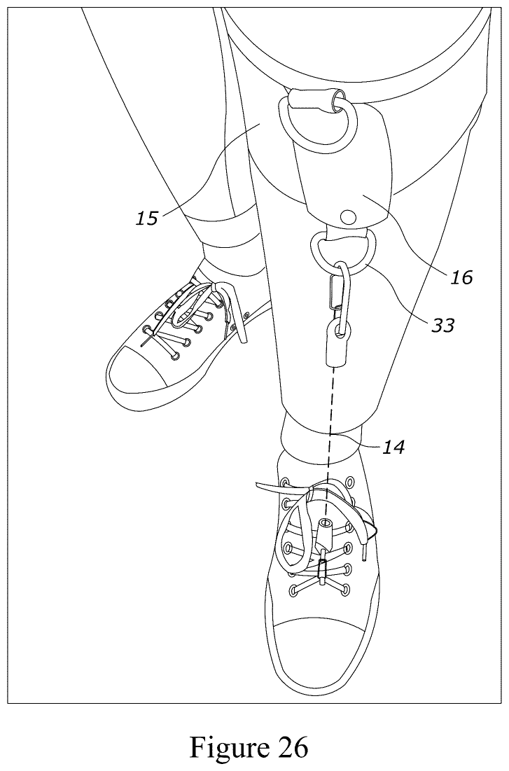

Turning to FIG. 25, it will be appreciated that the wearable postural and mobility assisting device 10 may further be provided with a head band 38 that is provided with a ring 33 (which may be D-shaped) on the front and/or back, from which one or more elastic bands can extend, such as to provide added stability to a wearer's head and/or shoulders.

The manner in which the wearable postural and mobility assisting apparatus 10 can be utilized to facilitate improved joint placement and motor function is only limited by the health care professionals' imagination. By way of example only, and in an effort to demonstrate the versatility and efficacy of the kit 10, a non-limiting number of sample configurations of the kit, as donned by a wearer, are presented in FIGS. 1-5 and 27-39b.

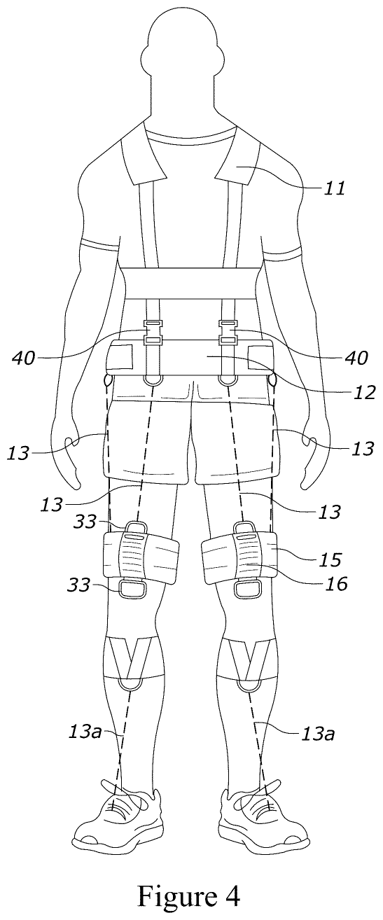

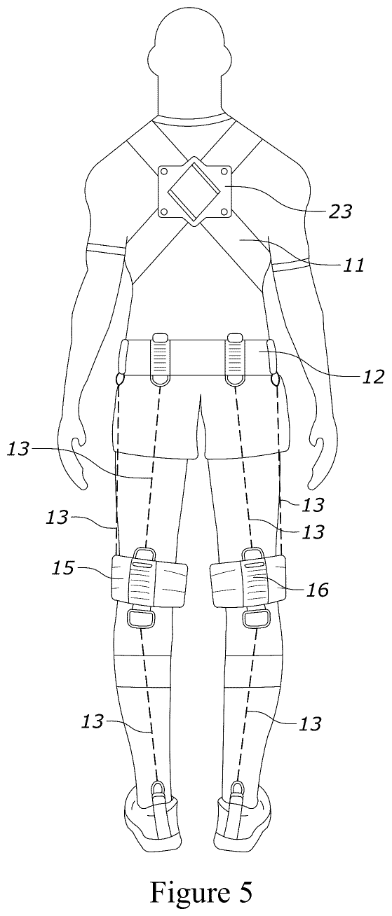

In a standard configuration, illustrated in FIGS. 4 and 5, a first set of elastic cords 13 are provided between anchors associated with the waist belt assembly 12 and upper anchors 33 (which may be D-shaped anchors of double D anchors 16) secured to each limb strap assembly 15. Additionally, a second set of elastic bands 13a, the elastic bands 13a being of a second elasticity that is different from a first elasticity of the elastic bands 13 of the first set, extend between below-the-knee limb strap assemblies 15 and the front of the shoes of the wearer. In FIG. 4, the different elasticities of the elastic bands or cords 13 and the elastic bands or cords 13a is illustrated by the line segments of the broken lines representing the elastic bands 13 having longer lengths than the line segments of the broken lines representing the elastic bands 13a. However, it will be appreciated by those skilled in the art that the different lengths of the line segments may represent different colors, patterns, or other indicia on elastic bands having different elasticities. It is further recognized that nominal tension of a given elastic band may be adjusted by changing the length of the band between two anchor points, such as through the use of the length-adjustable ratchet system as illustrated in FIG. 40, or the knob-adjustable system for effective elastic band length adjustment illustrated in FIG. 41, as discussed above.

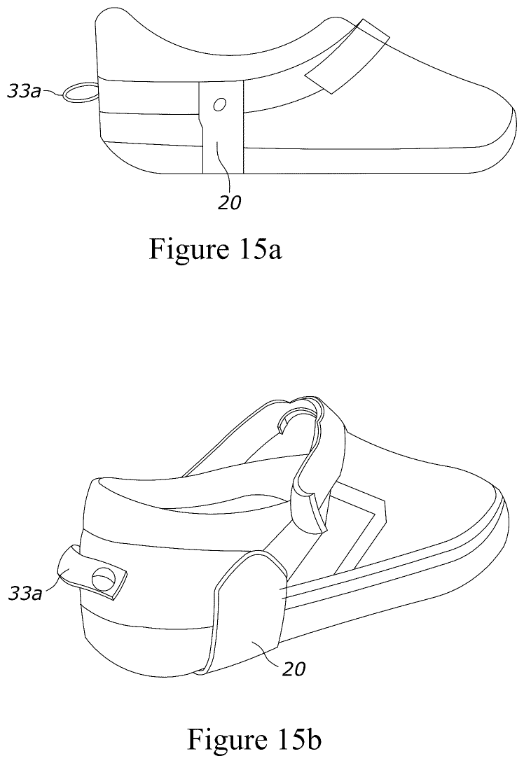

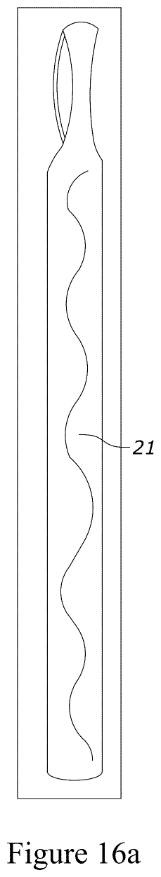

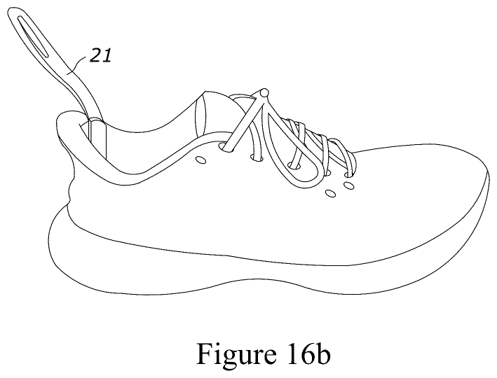

In this standard configuration, the side elastic bands 13 serve hip abduction, the front elastic bands 13 serve hip flexion, the front lower elastic bands 13a serve dorsiflexion, the rear elastic bands 13 (FIG. 5) extending between the waist belt assembly 12, behind the gluteal musculature, and the back of the legs (anchored to the above-the-knee limb strap assemblies 15) serve hip extension. The elastic bands 13 extending between the bottom of the above-the-knee limb strap assemblies 15 to the tops of the rear of the shoes of the wearer serve plantarflexion. The wearable postural and mobility assisting apparatus 10 may be provided with an over-shoe plantarflexion anchor, such as in FIGS. 15a, 15b, or alternatively, as illustrated in FIGS. 16a, 16b, an in-shoe plantarflexion anchor, including an elongate portion positionable within a shoe under a foot of a wearer, with a first end of the elongate portion positionable toward a toe portion of an article of footwear (e.g., a shoe), and an eyelet portion extending from a second end of the elongate portion, the second end being opposite the first end.

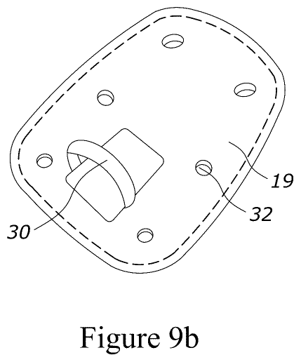

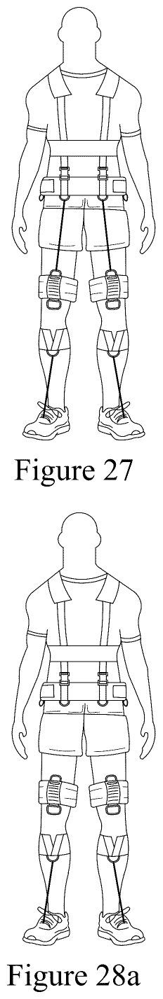

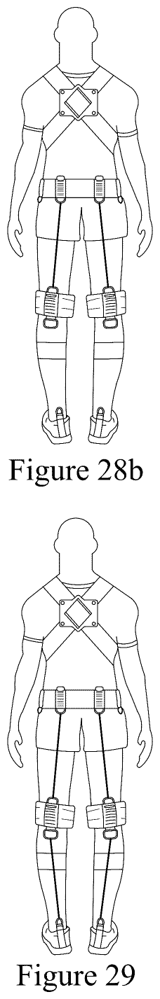

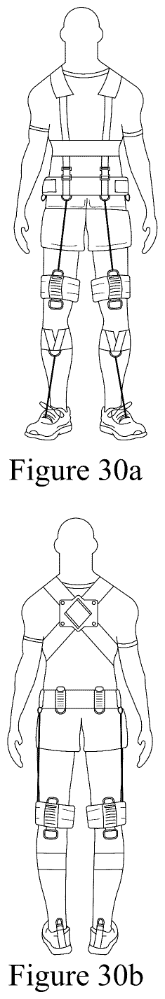

Turning to FIG. 27, a first configuration includes elastic bands placed overlaying hip flexors and ankle dorsiflexors. FIGS. 28a and 28b illustrate a second configuration, with elastic bands overlaying hip extensors and ankle dorsiflexors. FIG. 29 illustrates a third configuration, with elastic bands placed overlaying hip extensors and ankle plantar flexors. FIGS. 30a and 30b illustrate a fourth configuration, with elastic bands placed overlaying hip flexors, hip abductors, and ankle dorsiflexors. FIGS. 31a and 31b illustrate a fifth configuration, with elastic bands placed overlaying hip extensors, hip abductors, and ankle dorsiflexors. The wearable postural and mobility assisting apparatus 10 may be provided with at least one dorsiflexion anchor, which may be a no-shoe dorsiflexion anchor, such as illustrated in FIGS. 23a-23c, including an adjustable foot strap securable about a foot of a wearer and having a dorsiflexion anchor eye, which may be, for example, D-shaped, and positionable superiorly when the adjustable foot strap is secured about a foot of a wearer. Alternatively, a lace-in dorsiflexion anchor, such as illustrated in FIGS. 9a, 9b, may be provided, including a generally planar pad 19 having a plurality of shoelace-receiving holes securable by a shoelace to an article of footwear, such as a shoe, of a wearer, and having a dorsiflexion anchor eye, which may be D-shaped, provided on a superior side of the generally planar pad.

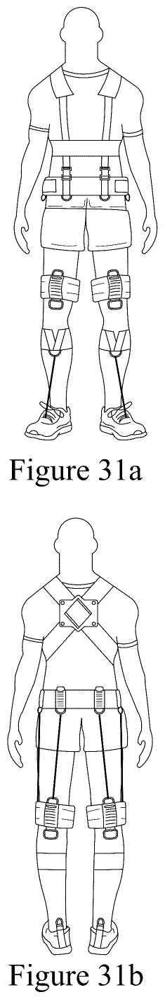

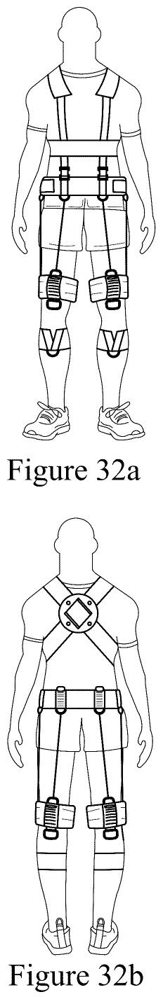

FIGS. 32a and 32b illustrate a sixth configuration, for pelvic stabilization, bilateral or unilateral. In this sixth configuration, the arrangement of elastic bands facilitates engagement of the hip flexor, the hip extensor, and hip abductor, facilitates postural and hip stability, improve proprioceptive awareness, and stabilize the pelvic floor.

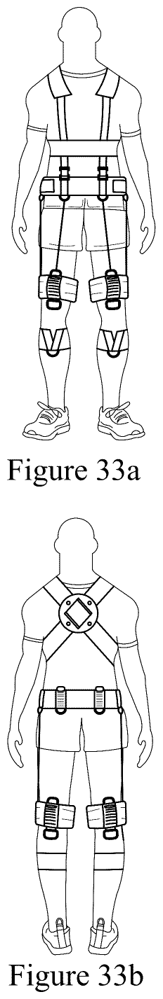

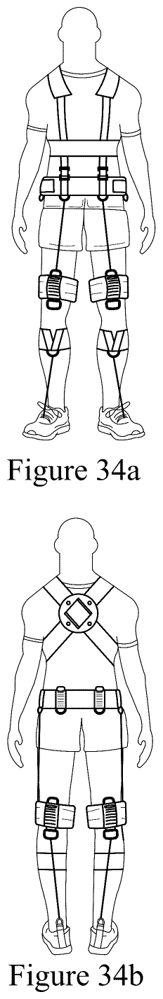

FIGS. 33a and 33b illustrate a seventh configuration. In this seventh configuration, the arrangement of elastic bands facilitates hip stability and provides correction of anterior or posterior pelvic rotation. FIGS. 34a and 34b illustrate an eighth configuration, wherein the arrangement of elastic bands facilitates swing via hip flexion right at toe off, facilitates knee flexion at the beginning of swing, and facilitates terminal knee extension at mid swing. This configuration is intended to promote limb advancement, bilateral or unilateral 1D hip flexion with dorsiflexion, and possible plantar flexion.

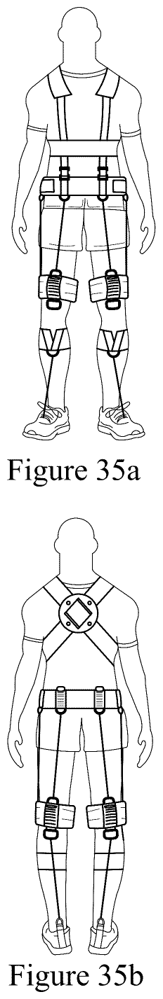

FIGS. 35a and 35b illustrate a ninth configuration, wherein the arrangement of elastic bands facilitates a neutral spine, correcting alignment and posture tendencies such as anterior or posterior pelvic tilt. The configuration also stabilizes and helps with engagement of floor and core.

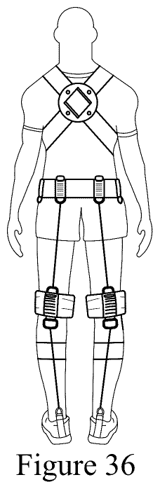

FIG. 36 illustrates a tenth configuration, promoting propulsion. In this tenth configuration, the arrangement of elastic bands facilitates heel off and initial swing phase of gate, stimulating hip extensors to contract promptly at the end of the swing phase.

Various configurations of the kit 10 of the present disclosure may be used to correct various anomalies including rotation anomaly such as inflare/outflare at the hip, pronation and supination at the ankle, and varus and valgus at the knee.

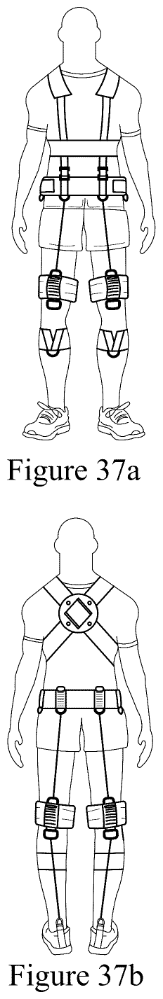

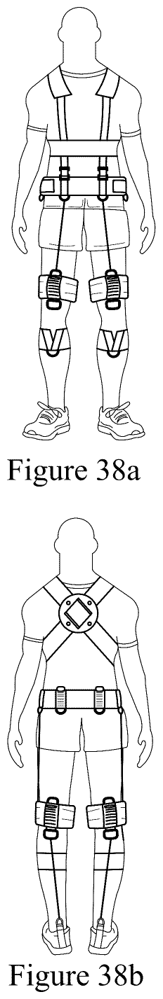

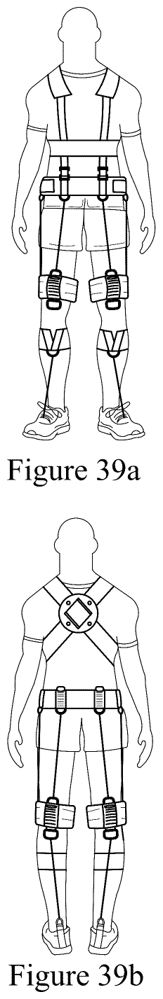

Additional configurations include an eleventh configuration, illustrated in FIGS. 37a and 37b, in which the arrangement of elastic bands helps to correct for unilateral lack of push off. In a twelfth configuration, illustrated in FIGS. 38a and 38b, the arrangement of elastic bands help to correct knee hyperextension. In a thirteenth configuration, illustrated in FIGS. 39a and 39b, the arrangement of elastic bands helps to correct for contralateral pelvic drop.

While each configuration described herein is numerically labeled, one of skill in the art will appreciate that this is merely for simplicity in describing the various configurations and should not be used to confer a sequence on the various configurations. While various embodiments and configurations have been described herein, it will be understood by those skilled in the art that variations may be made thereto that are within the scope of the appended claims.

References in the specification to “one embodiment,” “an embodiment,” “an illustrative embodiment,” “some embodiments,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

As used in the description and claims, the singular form “a”, “an” and “the” include both singular and plural references unless the context clearly dictates otherwise. For example, the term “anchor” may include, and is contemplated to include, a plurality of anchors. At times, the claims and disclosure may include terms such as “a plurality,” “one or more,” or “at least one;” however, the absence of such terms is not intended to mean, and should not be interpreted to mean, that a plurality is not conceived.

The term “about” or “approximately,” when used before a numerical designation or range (e.g., to define a length or pressure), indicates approximations which may vary by (+) or (−) 5%, 1% or 0.1%. All numerical ranges provided herein are inclusive of the stated start and end numbers. The term “substantially” indicates mostly (i.e., greater than 50%) or essentially all of a device, substance, or composition.

As used herein, the term “comprising” or “comprises” is intended to mean that the devices, systems, and methods include the recited elements, and may additionally include any other elements. “Consisting essentially of” shall mean that the devices, systems, and methods include the recited elements and exclude other elements of essential significance to the combination for the stated purpose. Thus, a system or method consisting essentially of the elements as defined herein would not exclude other materials, features, or steps that do not materially affect the basic and novel characteristic(s) of the claimed disclosure. “Consisting of” shall mean that the devices, systems, and methods include the recited elements and exclude anything more than a trivial or inconsequential element or step. Embodiments defined by each of these transitional terms are within the scope of this disclosure.

The examples and illustrations included herein show, by way of illustration and not of limitation, specific embodiments in which the subject matter may be practiced. Other embodiments may be utilized and derived therefrom, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A kit for configuring an exosuit for corrective, rehabilitative, and/or assistive use by a wearer, comprising:
(A) a shoulder harness including a first strap and a second strap, the first strap and second strap arranged such that the second strap crosses over the first strap, each of the first strap and the second strap passing through a harness keeper at the intersection where the second strap crosses over the first strap, the first strap passing through the harness keeper in a first direction and the second strap passing through the harness keeper in a second direction perpendicular to the first direction;
(B) a waist belt to which each of the first strap and the second strap of the shoulder harness is selectively securable, the waist belt including at least two laterally adjustable anchor points;
(C) a first connection strap for selectively securing the first strap of the shoulder harness to the waist belt;
(D) a second connection strap for selectively securing the second strap of the shoulder harness to the waist belt;
(E) a plurality of elastic bands;
(F) at least one limb strap assembly, each of the at least one limb strap assemblies including an adjustable strap securable about a limb of a wearer, and one of a group comprising
(i) at least one adjustable anchor to which at least one of the elastic bands is selectively securable, and
(ii) at least two D-shaped anchors to each of which at least one of the elastic bands is selectively securable;
(G) at least one plantarflexion anchor, each of the at least one plantarflexion anchors being one of a group comprising
(i) an over-shoe plantarflexion anchor, including at least a first strap securable about an upper of a shoe, and a second strap securable to the first strap about a sole of the shoe, and
(ii) an in-shoe plantarflexion anchor, including an elongate portion positionable within a shoe under a foot of a wearer with a first end of the elongate portion positionable toward a toe portion of the shoe, and an eyelet portion extending from a second end of the elongate portion, the second end being opposite the first end; and
(H) at least one dorsiflexion anchor, each of the dorsiflexion anchors being one of a group comprising
(i) a no-shoe dorsiflexion anchor including an adjustable foot strap securable about a foot of a wearer and having a D-shaped dorsiflexion anchor eye positionable superiorly when the adjustable foot strap is secured about a foot, and
(ii) a lace-in dorsiflexion anchor including a generally planar pad having a plurality of shoelace-receiving holes securable via a shoelace to a shoe of a wearer and having a D-shaped dorsiflexion anchor eye on a superior side of the generally planar pad.

2. The kit of claim 1, wherein the shoulder harness keeper is made of low density polyethylene (LDPE).

3. The kit of claim 1, wherein each of the first and second connection straps is a hook-and-loop connection strap.

4. The kit of claim 1, wherein the waist belt includes at least one portion with a multiplicity of hooks and at least one portion with a multiplicity of loops, to which the portion with the multiplicity of hooks is selectively securable.

5. The kit of claim 1, wherein at least one of the limb strap assemblies includes the at least two D-shaped anchors, and wherein the at least two D-shaped anchors are adjustably securable to the adjustable strap securable about a limb of a wearer by a hook-and-loop connection.

6. The kit of claim 1, wherein one or more of the first strap of the shoulder harness, the second strap of the shoulder harness, the waist belt, and the adjustable foot strap of the lace-in dorsiflexion anchor is made of polychloroprene (Neoprene) material and is provided with a multiplicity of loops.

7. The kit of claim 1, wherein the elastic bands are non-latex.

8. The kit of claim 1, wherein with the elastic bands are configured to be placed over hip flexors and ankle dorsiflexors of a wearer.

9. The kit of claim 1, wherein with the elastic bands are configured to be placed over hip extensors and ankle dorsiflexors of a wearer.

10. The kit of claim 1, wherein with the elastic bands are configured to be placed over hip extensors and ankle plantarflexors of a wearer.

11. The kit of claim 1, wherein with the elastic bands are configured to be placed over hip flexors, hip abductors, and ankle dorsiflexors of a wearer.

12. The kit of claim 1, wherein with the elastic bands are configured to be placed over hip extensors, hip abductors, and ankle dorsiflexors of a wearer.

13. The kit of claim 1, wherein the elastic bands are color coded, with a first color indicating a first elasticity and a second color indicating a second elasticity different from the first elasticity.

14. The kit of claim 1, further including at least one rigid body-facing member to which one or more anchors are secured, the at least one rigid body-facing member being securable to at least one of a shin, a calf, a thigh, an abdomen, a chest, a forearm, an upper arm, a shoulder, a neck, an ankle, a knee, and a foot.

15. The kit of claim 1, further comprising at least one anchor selectively securable to at least one side of a foot of a wearer and selectively securable via at least one of the elastic bands to one of the at least one limb strap assemblies, to correct for at least one of inversion and eversion.

16. The kit of claim 15, wherein with the elastic bands are configured to correct for at least one of inversion and eversion and to assist in at least one of plantarflexion or dorsiflexion.

17. The kit of claim 16, wherein the at least one anchor selectively securable to at least one side of a foot of a wearer and at least one of the at least one plantarflexion anchor or the at least one dorsiflexion anchor are disposed about a common strap selectively securable to one of a foot or a shoe of a wearer.

18. The kit of claim 16, wherein the at least one anchor selectively securable to at least one side of a foot of a wearer, the at least one plantarflexion anchor, and the at least one dorsiflexion anchor are disposed about a common strap selectively securable to one of a a foot or an article of footwear of a wearer.

19. The kit of claim 1, wherein the at least one limb strap assembly includes the at least one adjustable anchor to which at least one of the elastic bands is selectively securable, and the at least one adjustable anchor includes a length adjustment mechanism by which tension of one or more elastic bands secured to the adjustable anchor is adjusted due to a change in nominal stretch of the one or more elastic bands.

20. The kit of claim 1, wherein one or more of the elastic bands is secured to a ratchet system by which a length of that elastic band and ratchet system is adjustable.

21. The kit of claim 1, wherein one or more of the elastic bands is secured to an adjustable cable system by which an effective length of each elastic band secured to the adjustable cable system is adjustable.

22. The kit of claim 21, wherein the adjustable cable system is adjusted by a knob.

23. The kit of claim 1, further comprising a head band including an adjustable strap securable about a head of a wearer, the adjustable strap including at least one of a forward and outwardly-facing head anchor and a rearward and outwardly-facing head anchor.

24. An exosuit, comprising:
a shoulder harness including a first strap and a second strap, wherein the first strap and the second strap are configured to pass through and intersect at a harness keeper;
a waist belt removably couplable to the first strap and the second strap of the shoulder harness, wherein the waist belt comprises at least two laterally adjustable anchor points;
a first connection strap for selectively securing the first strap of the shoulder harness to the waist belt;
a second connection strap for selectively securing the second strap of the shoulder harness to the waist belt;
a plurality of elastic bands;
at least one limb strap assembly comprising an adjustable strap securable about a limb of a wearer, and one of:
at least one adjustable anchor to which at least one of the plurality of elastic bands is selectively securable, and
at least two anchors to which at least one of the plurality of elastic bands is selectively securable;
at least one plantarflexion anchor comprising one of:
an over-shoe plantarflexion anchor or an in-shoe plantarflexion anchor; and
at least one dorsiflexion anchor, comprising one of:
a no-shoe dorsiflexion anchor or a lace-in dorsiflexion anchor.
